(19) United States
(12) Patent Application Publication
(10) Pub. No.: US 2024/0109043 A1
(43) Pub. Date: Apr. 4, 2024

(54) DOUBLE-TUMBLE MIXER

(71) Applicant: RADIA, Plymouth, MN (US)

(72) Inventors: Stephen John Carlson, Shorewood, MN (US); Jeffrey David Heinrichs, Waconia, MN (US); Erik John Sundine, Monticello, MN (US)

(21) Appl. No.: 18/367,543

(22) Filed: Sep. 13, 2023

Related U.S. Application Data
(60) Provisional application No. 63/413,076, filed on Oct. 4, 2022.

(51) Int. Cl. B01F 29/10; B01F 29/32; B44D 3/08

(52) U.S. Cl. CPC B01F 29/10; B01F 29/32; B44D 3/08; B01F 2101/30

(57) ABSTRACT

A multi-axis mixing apparatus includes a first motor and a frame supporting the first motor, the first motor configured to selectively rotate a first rotatable assembly about a first axis. The apparatus also includes a second rotatable assembly rotatably supported by the first rotatable assembly, where the second rotatable assembly is rotatable about a second axis. The second rotatable assembly includes a clamping mechanism configured to receive and hold a container containing contents to be mixed, where when the first motor causes the first rotatable assembly to rotate about the first axis, the rotation of the first rotatable assembly about the first axis causes the second rotatable assembly to rotate about the second axis, and where the second axis is substantially perpendicular to the first axis.

### CROSS-REFERENCE TO RELATED APPLICATIONS

The application claims the benefit of U.S. Provisional Patent Application having Ser. No. 63/413,076 titled “DOUBLE-TUMBLE MIXER” filed Oct. 4, 2022, the entire contents of which are incorporated by reference for all purposes herein.

### BACKGROUND

The present invention is directed to mixing, and is more specifically directed to multi-axis mixing and mixers utilizing a double-tumble motion, related methods, and features thereof.

It is frequently desirable to mix various substances, such as paint, and including a liquid suspension and colorant/tint, etc. Generally, liquid and/or semi-liquid with solids therein such as paint frequently start as various separate substances or colors that are then mixed into a desired mixture, such as to achieve a certain color, tone, hue, reflectivity, and the like. In order to promote more complete and/or more even mixing, various mixers can utilize other forms of agitation, such as shaking and/or rotational movement along one or more axis during mixing.

At present, mixers can be categorized as for example, gyroscopic mixers, vortex mixers, shaking mixers, agitation (about an axis) mixers, agitation and translation mixers, and “random” movement mixers. Each type of mixer to date has had various limitations, such as taking too long to mix, being unsuitable for automation, performing incomplete mixing, among other challenges.

Therefore, there is a need for an improved mixing apparatus and related methods that provides a mixing experience that provides very thorough mixing in a relatively short period of time, and that is suitable for use with automation.

### SUMMARY

The present invention overcomes a number of shortcomings of the prior art by introducing a multi-axis mixing motion according to two perpendicular tumble axes. The multi-axis, double-tumble mixing motion provides improved mixing properties, and is suitable for use with automated insertion and/or extraction as relates to the mixer in various use cases.

According to a first embodiment of the present disclosure, a multi-axis mixing apparatus is disclosed. According to the first embodiment, the apparatus includes a first motor and a frame supporting the first motor, the first motor configured to selectively rotate a first rotatable assembly about a first axis. The apparatus also includes a second rotatable assembly rotatably supported by the first rotatable assembly, where the second rotatable assembly is rotatable about a second axis. Also, according to the first embodiment, the second rotatable assembly includes a clamping mechanism configured to receive and hold a container containing contents to be mixed, where when the first motor causes the first rotatable assembly to rotate about the first axis, the rotation of the first rotatable assembly about the first axis causes the second rotatable assembly to rotate about the second axis, and where the second axis is substantially perpendicular to the first axis.

According to a second embodiment of the present disclosure, another multi-axis mixing apparatus is disclosed. According to the second embodiment, the apparatus includes a first motor and a second motor. The apparatus also includes a frame supporting the first motor, the first motor configured to selectively rotate a first rotatable assembly about a first axis. The apparatus also includes a second rotatable assembly rotatably supported by the first rotatable assembly, where the second rotatable assembly is rotatable about a second axis, and where the second motor is configured to selectively rotate the second rotatable assembly about the second axis. Also, according to the second embodiment, the second rotatable assembly includes a clamping mechanism configured to receive and hold a container containing contents to be mixed, and where the second axis is substantially perpendicular to the first axis.

According to a third embodiment of the present disclosure, a method of multi-axis mixing is disclosed. According to the third embodiment, the method includes receiving a container containing contents to be mixed at a clamping mechanism such that the container is held by the clamping mechanism, where a first rotatable assembly rotatably supports a second rotatable assembly that comprises the clamping mechanism holding the container. The method also includes rotating the first rotatable assembly about a first axis and rotating the second rotatable assembly about a second axis. Also, according to the third embodiment, causing the rotating of the first rotatable assembly about the first axis causes the second rotatable assembly to rotate about the second axis, and where the second axis is substantially perpendicular to the first axis.

These and various other features and advantages will be apparent from a reading of the following detailed description.

### BRIEF DESCRIPTION OF THE DRAWINGS

FIG. 1 is an upper perspective view of a double-tumble mixer, according to various embodiments.

FIG. 2 is a lower perspective view of the double-tumble mixer of FIG. 1, according to various embodiments.

FIG. 3 is a cross-sectional profile view of the double-tumble mixer of FIG. 1 loaded with a container for mixing, according to various embodiments.

FIG. 4 is a lower perspective view of a dual tumble assembly of the mixer of FIG. 1, according to various embodiments.

FIG. 5 is a profile view of the dual tumble assembly of FIG. 4, according to various embodiments.

FIG. 6 is an upper perspective view of a base of the mixer of FIG. 1, according to various embodiments.

FIG. 7 is a cross-sectional profile view of the base of FIG. 6, according to various embodiments.

FIG. 8 is a perspective view of various components of the dual tumble assembly of the mixer of FIG. 1, according to various embodiments.

FIG. 9 is a bottom view of a linear actuator system of the base of FIG. 6 in an extended position, accruing to various embodiments.

FIG. 10 is a bottom view of the linear actuator system of FIG. 9 in a retracted position, accruing to various embodiments.

FIG. 11 is a side view of the linear actuator system of FIG. 9 in the extended position, accruing to various embodiments.

FIG. 12 is a bottom view of the linear actuator system of FIG. 9 in the retracted position, accruing to various embodiments.

FIG. 13 is a perspective view of a prior art gyroscopic mixer loaded with a container for mixing.

FIG. 14 shows the axes of movement of the prior art gyroscopic mixer of FIG. 13.

FIG. 15 is a perspective view of a double-tumble mixer loaded with a container for mixing, according to various embodiments.

FIGS. 16A-16C show various angles and rotation movements of a double-tumble mixer, according to various embodiments.

FIGS. 17A-17C show the various movements of a substance being mixed within a container held by a mixer when moved according to the double-tumble movements of FIGS. 16A-16C.

FIGS. 18A-18F show a sequential procession of snapshots of a double-tumble mixing action, according to various embodiments.

FIGS. 19 and 20 show test results for a prior art gyroscopic mixer.

FIGS. 21 and 22 show test results for a double-tumble mixer, according to various embodiments.

FIGS. 23 and 24 show test results for a prior art gyroscopic mixer and a double-tumble mixer with no draw-down.

FIG. 25 is a partially transparent view of an alternative embodiment of a double-tumble mixer that utilizes a belt-based drive.

### DETAILED DESCRIPTION

Disclosed are embodiments of an easy-to-use mixing apparatus and related methods that use multi-axis, double-tumble motion to completely and efficiently mix contents in containers ranging from roughly a quart or less to larger than five gallons. Example disclosed embodiments further provide for improved and assisted extraction of a container from the mixing apparatus, such as through automation.

Mixing of a container's contents, such as a paint can containing paint components, can be done by various movements of the container itself. Axial spin-based mixing involves rotating a container around a spin axis that passes through a tubular center of a round, cylindrical can; i.e., that passes through a center top and center bottom of the can's upper and lower ends, respectively. In contrast to spin-based mixing, tumble-based mixing motion, in terms of a typical cylindrical container or paint can, is a rotational movement of the paint can about an axis that is not the spin axis, and can be substantially perpendicular to the spin axis. E.g., a tumble motion is an end-over-end type rotation, in contrast to a spin-type rotation about a spin axis.

Tumble action and movement of a container has been shown to beneficially increase a rate at which contents can be mixed in the context of paint cans and their contents. Therefore, as used herein, a “tumble” axis is an axis about which a container is rotated, e.g., during mixing, and that is defined to be non-aligned with a vertical can axis (e.g., a can sitting on a table or surface), such as would be used for a spin movement for a paint can in a typical gyroscopic mixer. Two-axis tumble action for mixing is effective, but has been to-date challenging to implement.

Disclosed herein are embodiments of dual-axis, double-tumble mixers and mixing motions associated therewith that utilize two tumble axes that are either perpendicular to each other or substantially so but offset by some amount, which each of the two tumble axes is also substantially perpendicular to a vertical “can” or “spin” axis. Although embodiments herein discuss generally cylindrical paint cans as examples of containers with contents to be mixed, other types of containers and other non-paint materials and compositions, liquid, solid, flowable and the like can be mixed with disclosed mixers.

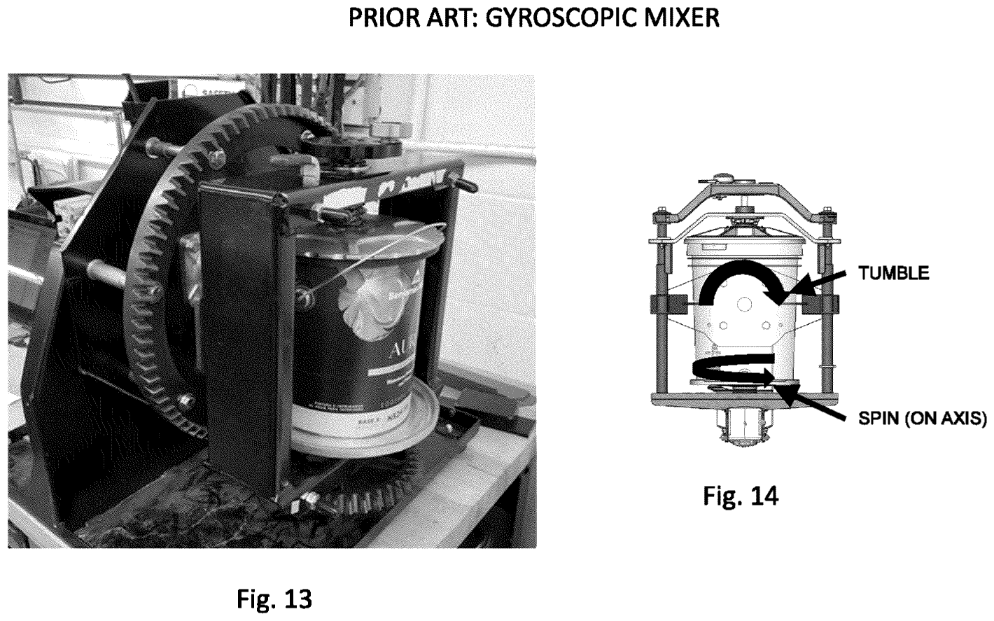

Some existing mixers utilize, e.g., one spin axis in combination with only one tumble axis for mixing. This combination of spin and tumble is sometimes referred to as “gyroscopic mixing” (see examples at FIGS. 13 and 14, discussed below). However, spin-axis mixing is generally ineffective at mixing when used as a sole mixing axis, and can still be relatively ineffective even in combination with a single tumble axis rotation. Therefore, there is a desire for even greater mixing efficiencies and speeds.

An identified challenge in prior art mixers has relates to a lack of complete mixing of colorants, which can be predominantly gathered in the paint container chime. Chime refers to edges or corners within a typical cylindrical paint can. Embodiments of the present disclosure are particularly suited for one-gallon containers such as paint cans, but can be used with any size container, such as sample paint cans, five-gallon paint cans, and the like.

In existing gyroscopic mixers, a container is fully rotated (spinning motion) on its own axis and is also sometimes rotated (tumbled) on a perpendicular axis to the rotational can/spin axis. Gyroscopic mixing can be reasonably adequate for mixing large containers, such as five-gallon paint cans, and can offer sufficient mixing speed for larger containers. However, gyroscopic mixers can have particular difficulty mixing smaller, e.g., one-gallon, containers for various reasons. Thus, mixing quickly and completely, especially for smaller containers, remains a challenge.

In addition to mixing challenges, existing gyroscopic and vortex mixers have also had challenges related to loading and unloading of containers while maintaining adequate mixer strength and robustness. Achieving sufficient physical robustness and strength for multi-axis mixers can be challenging in general. This can be due in part to multiple mixing axes and relatively complex construction, such as multiple independent or partially independent rotating assemblies with multiple degrees of freedom. In addition to strength constraints, it is also beneficial to have easy access to a container to be mixed, such as by having one or more sides open for loading and unloading of containers. Allowing for such open access areas can complicate strengthening and bracing.

For example, a mixer can be provided with a generally C-shaped clamp assembly and frame, which can allow for a container to be accessed and grabbed from the sides, and can also facilitate automation systems and features, such as various clamps, arms, or grabbers (which can grab container from sides and/or bottom) or features that otherwise pass through various portions of the mixer.

In alternative embodiments of mixers discussed herein, one or more sides of the mixer apparatus can be closed or partially closed while maintaining double-tumble mixing operation. In alternative and optional embodiments with at least partially closed sides to a mixer, mixing speeds can be further increased accordingly.

One beneficial aspect of easy access, quick, and efficient mixing is in cases of volume, including systems that utilize aspects of automation. Automation aspects can include mechanisms for sliding a container over, mechanisms that load/unload containers into/from receiving area of a mixer, among many others. A container of paint is optionally pre-tinted, and movement and mixing can be fully automatic. In various cases, a container is received and clamped top-to-bottom, facilitating loading and unloading mechanisms, including in cases of automation. In some embodiments, a loading process of a container into the mixer can be done from a front of a tumbling clamp assembly, allowing for convenient loading in embodiments utilizing an automatic loader/unloader. The clamping of the container can optionally occur manually (e.g., by a person) instead of automatically, e.g., in an alternative, non-automated setting.

Disclosed embodiments provide for an entirely new way in which to move a container, such as a paint can, with contents being thoroughly mixed as a result. Instead of a single tumble movement and a spin movement, and as described herein, two tumble movements (and preferably no axial spin movement) are provided in a single mixer, which provides improved mixing characteristics. Therefore, and in various embodiments, a “double-tumble” mixing movement or action includes two substantially non-aligned tumble mixing axes (e.g., perpendicular or mutually orthogonal) that are preferably each also non-aligned with a vertical can (spin) axis of a container to be mixed.

As described in various embodiments herein, a three-axis space can be defined with a container, such as a paint can, as a frame of reference. A spin/can axis is defined as an axis that passes through top and bottom ends of a container such as a round paint can with a flat circular top and bottom, and has been an axis about which a paint can is caused to be rotated or spun during a mixing process. In the same three-dimensional space, two additional axes can be defined such that three axes are mutually substantially perpendicular (or in some cases orthogonal) to each other, e.g., as in an x, y, and z-axis space. It is typical in existing mixers to use a spin movement of the can as at least one mixing axis. The present disclosure relates to mixing by rotating an, e.g., cylindrical can or container, in multiple axes (e.g., primary/first and secondary/second) without utilizing a spin axis as one of the axes of rotation or mixing.

According to various embodiments utilizing a double-tumble mixer, when the spin axis is (momentarily) horizontal, the container is tumbled end over end by the secondary tumble axis. When the container is vertical, the container is momentarily rotated on its spin axis by the primary tumble axis motion. Between these positions, the container is rotated at a steadily varying angle by the primary tumble action, but always end over end by the secondary tumble action. The mechanisms and systems that achieve this double-tumble mixing action are described in further detail, below.

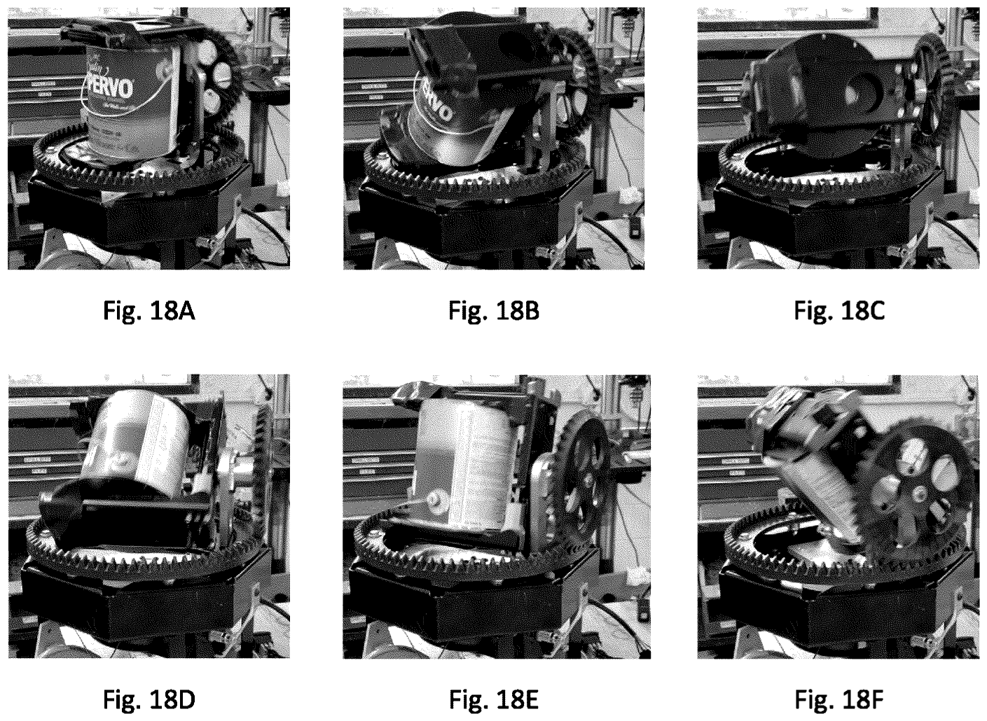

Stated differently, and according to the double-tumble mixing movement described herein, a container, e.g., a paint can, is tumbled end over end in two directions about a first tumble axis. This first tumble axis can be referred to as the primary tumble axis and can correspond to an axis of a motor, and also a rotation caused by the motor. The container is preferably also tumbled about an axis perpendicular to the container's spin axis, e.g., a second (or secondary) tumble axis. This secondary tumble axis itself is rotated. In other words, the secondary tumble axis is itself tumbled. This resulting second tumble movement is referred to herein as a secondary tumble action according to a secondary tumble axis. See FIGS. 18A-18F for various sequential frames of an example double-tumble mixing process contemplated herein.

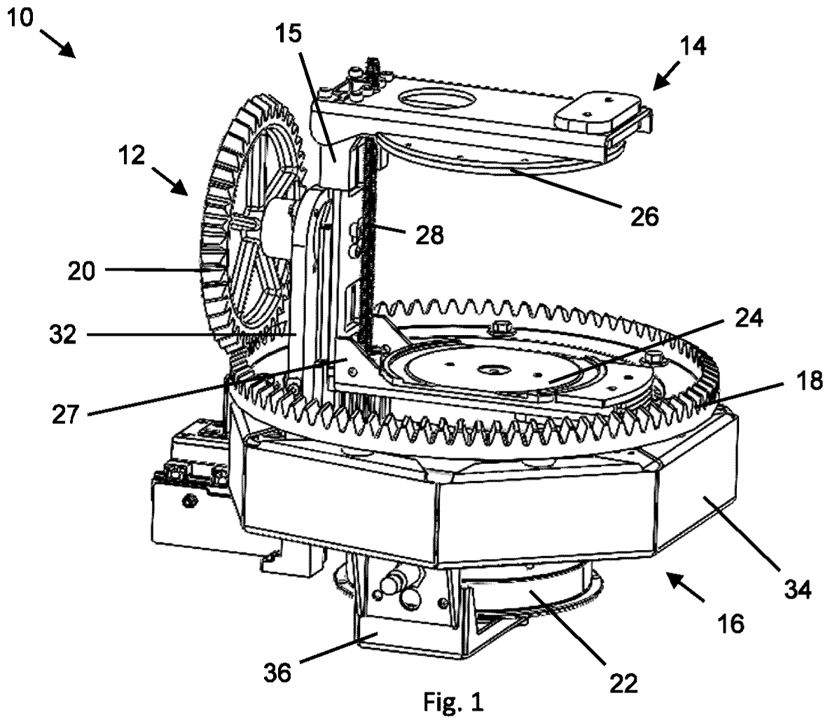

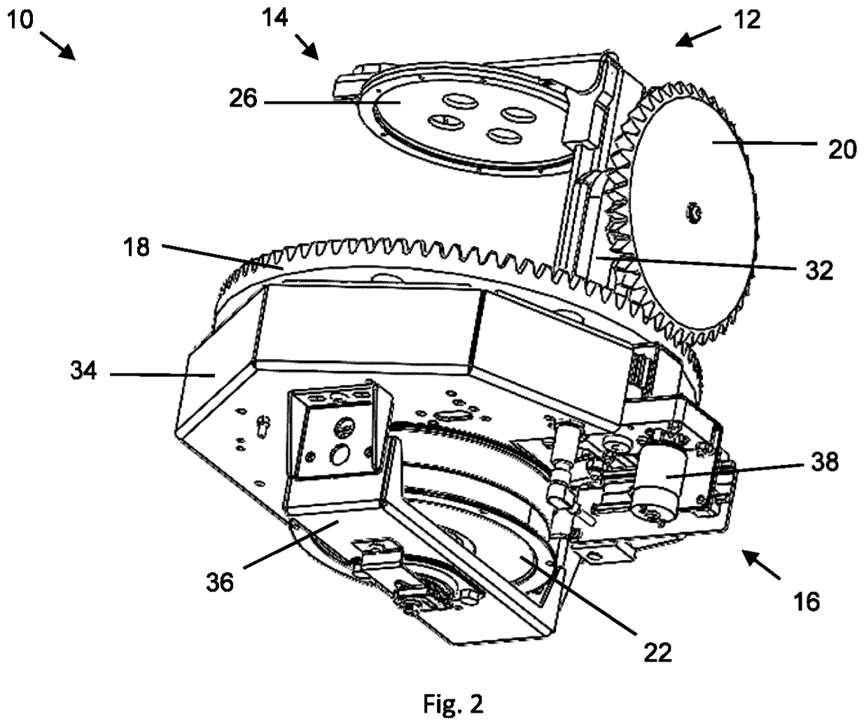

Turning now to the Figures, and in particular the views shown in FIGS. 1-12, an example double-tumble, multi-axis mixer 10, associated mixing action, linear actuation/clamping, and methods are described. As shown, the mixer 10 comprises a primary rotatable, dual tumble assembly 12 and a base 16. The rotatable dual tumble assembly 12 further comprises a secondary rotatable, tumbling clamp assembly 14. The tumbling clamp assembly 14 is configured to securely hold and balance a container 40 (e.g., a paint can), with an optional handle or bail 42, for mixing. According to various embodiments herein, mixing using mixer 10 is preferably a non-invasive process, meaning the container 40 preferably remains closed/sealed during a mixing process.

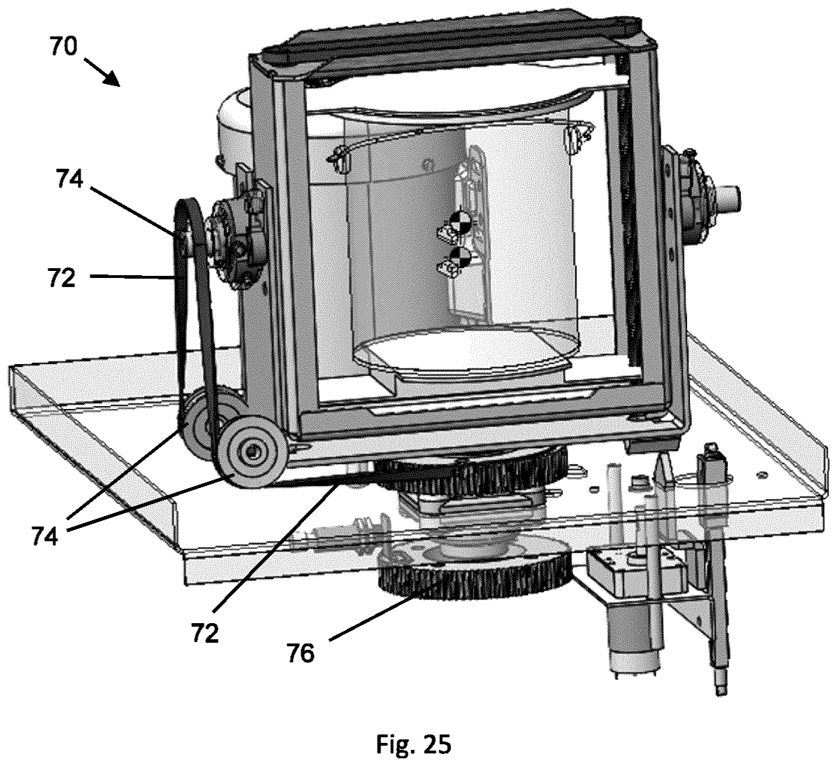

The base 16 of the mixer 10 can be a support frame that remains stationary during mixing. Using the base 16 as a point of reference, the dual tumble assembly 12 rotates about a first vertical axis, and thus in a horizontal plane. The dual tumble assembly 12 itself creates a second frame of reference about which a secondary tumble movement occurs according to a second axis which itself rotates about the primary tumble axis. The base 16 includes a frame 34 for attaching and supporting components of the base 16, such as a motor 22. The motor 22 is itself held to the frame 34 by a motor bracket 36 positioned on an underside of the frame 34. The motor bracket 36 in turn attaches an optionally direct-drive electric motor 22 to the frame 34 of the base 16. In other embodiments, the motor 22 is not direct drive, can be a standard motor, and can utilize one or more belts, pulleys, gears, and the like for operation (see alternative mixer 70 of FIG. 25). As shown, the motor 22 is operatively connected to vertically-extending drive shaft 23. In the shown embodiment, and provided on the frame 34 is a larger diameter, preferably horizontal and track-like, stationary drive gear 18 about which a secondary gear interfaces to simply and reliably impart double-tumble motion as described in greater detail, below.

The base 16 supports the dual tumble assembly 12 by way of the motor 22 and drive shaft 23, which in turn are used to rotate the dual tumble assembly 12 in a horizontal plane. As the dual tumble assembly 12 rotates horizontally, a second, tumble assembly gear 20, is, as shown, interfaced at an angle to drive gear 18. The tumble assembly gear 20 is configured to be freely movable in a circular range, but as shown is passively operated and thus not equipped with a motor itself. In that sense, the tumble assembly gear 20 is configured to be moved as a result of other parts moving and in a corresponding manner. As the dual tumble assembly 12 is rotated, the gear 20 is caused to be rotated horizontally, and while interfaced with gear 18, clamp assembly 14 begins to rotate in a secondary vertical plane (with a horizontal spin axis) as the dual tumble assembly 12 rotates in a primary horizontal plane (with a vertical spin axis). The dual tumble assembly 12 also supports and includes the parts of the clamp assembly 14.

In various embodiments, the motor 22 is a first motor, and a second motor is provided to operatively rotate the clamp assembly 14, optionally independently from a rotation of the first motor. The first and second motors can optionally be independently controlled, e.g., at different power levels and/or RPMs, and optionally according to different mixing programs, cycles. In some embodiments, the first and second motors, if present, can be controlled to both operate at the same speed.

Preferably, various masses, including components of a container 40, are substantially balanced about various axes of rotation to minimize noise, vibration, and harshness (NVH).

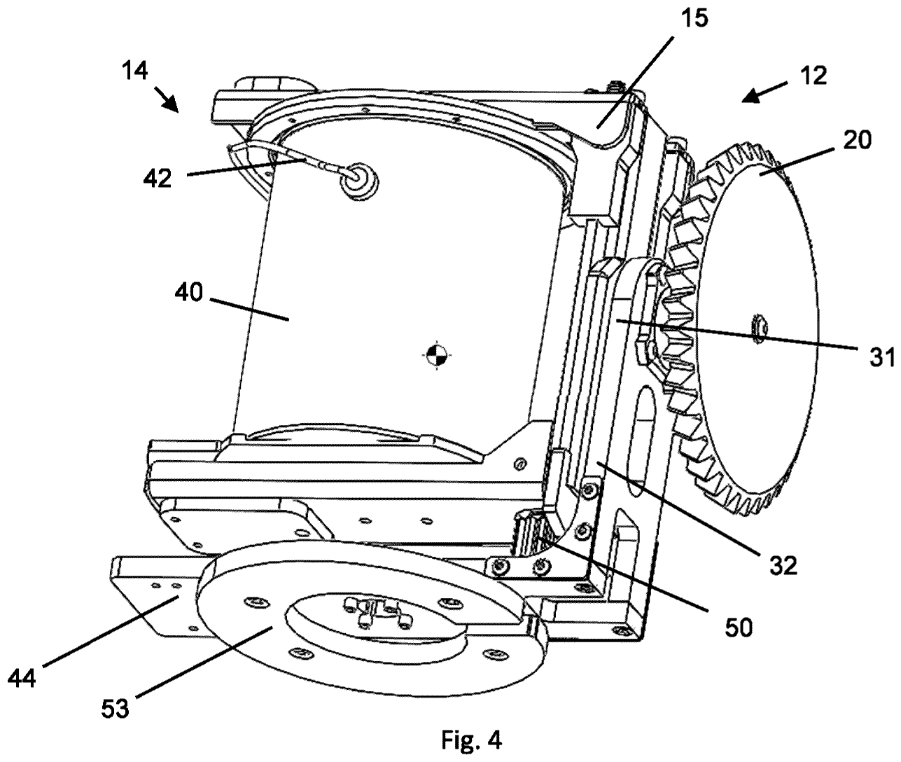

The dual tumble assembly 12 is preferably composed of the generally C-shaped tumbling clamp assembly 14, including an adjustable movable top frame portion 15, the clamp assembly 14 rotatably mounted to an L-shaped support frame 32 with base portion 44 and vertical portion 31, and an indexing cam 53 (see FIG. 4). The entire dual tumble assembly 12 is operatively attached, and optionally at least partially supported by, the motor shaft 23 located in the base 16.

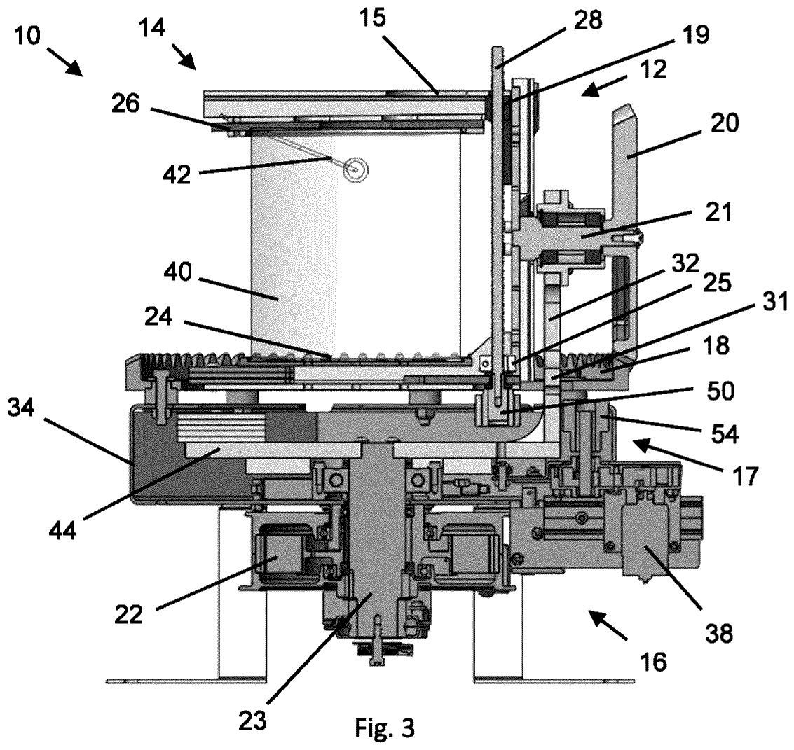

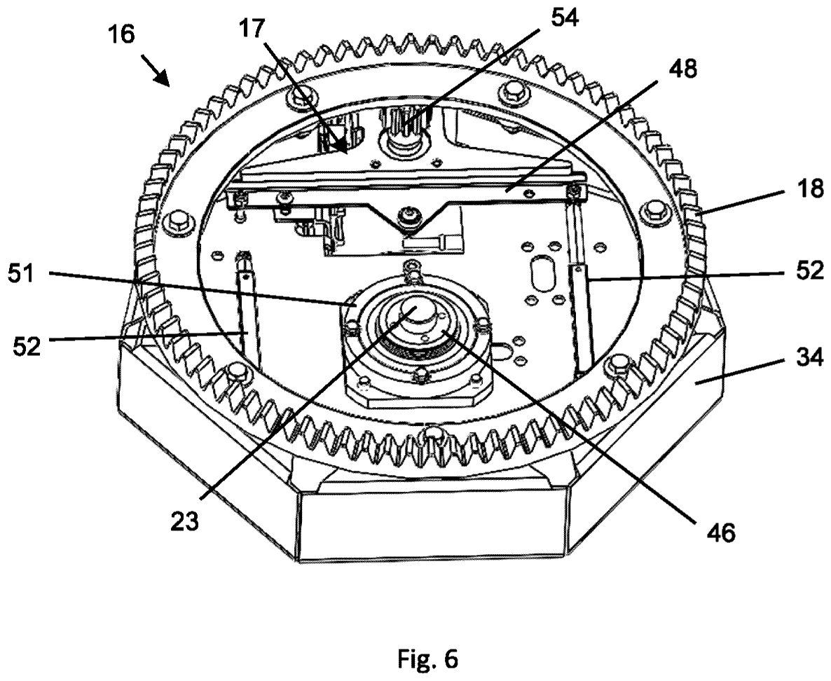

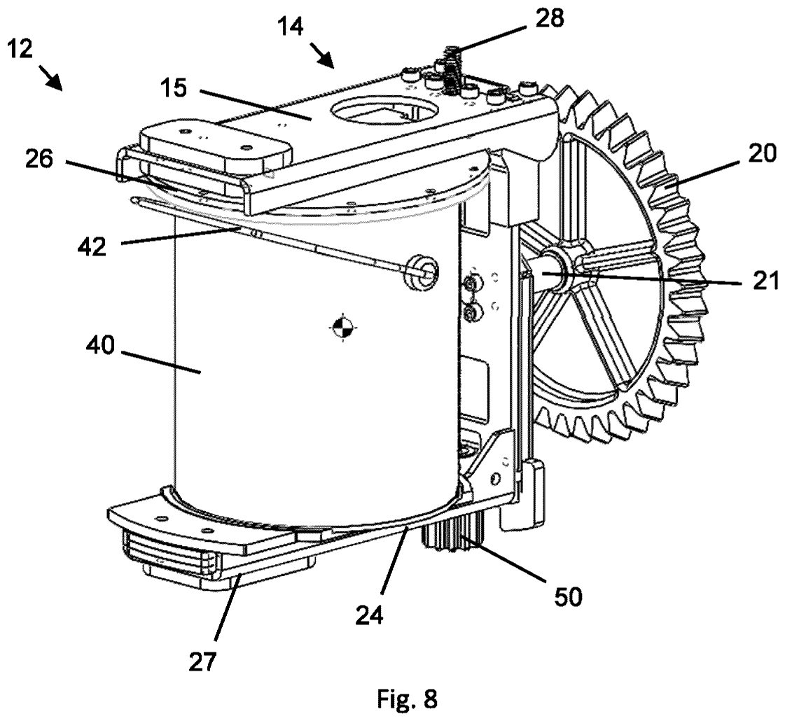

With reference to FIGS. 3 and 8, the clamp assembly 14, configured to clamp and release a container 40 for mixing, includes a clamping drive system 17. The clamping drive system 17 as shown includes parts of both the base 16 and dual tumble assembly 12 that are selectively connectable as further described below. The clamping drive system 17 includes a clamping leadscrew 28 operatively connected to and drivable by a driven clamp gear 50. The driven clamp 50 is removable interfaced with a drive motor gear 54 based on movement by one or more linear actuators 52 (see also FIGS. 6 and 9-12).

The drive system 17 (see FIGS. 11 & 12) further includes a clamp motor 38 and a leadscrew threaded carrier nut 19 connected movable to top plate 26. Also shown a clamp collar 25, which can also be provided to provide a fixed surface above and/or below a leadscrew bearing so the leadscrew 28 is held in position with gear 50 below. The drive system 17 through leadscrew 28 also interfaces with a movable first (top) plate 26 connected to a top frame and a second (bottom) plate 24 connected to a fixed bottom frame 27 of the clamp assembly 14. The top plate 26 and the bottom plate 24 are configured to be movable towards each other or away from each other according to the nut 19 moving as the leadscrew 28 is rotated by the clamp motor 38. According to various embodiments, at least one of the first (top) plate and the second (bottom) plate has at least one indentation for receiving a portion of the container 40. For example, the top and/or bottom plates 24, 26 can include a conforming indentation with a rim or lip set back such that a lip of the container 40 is held securely. As shown, clamping components, including the nut 19, the top and bottom plates 26, 24, and the clamp gear 50 are parts of the tumbling clamp assembly 14, which is itself part of the dual tumble assembly 12, as described herein. In various embodiments, the top plate 26 is movable and the bottom plate 24 is fixed. In other embodiments, the top plate 26 is fixed and the bottom plate 24 is movable. In yet other embodiments, both the top plate 26 and bottom plate 24 are both movable.

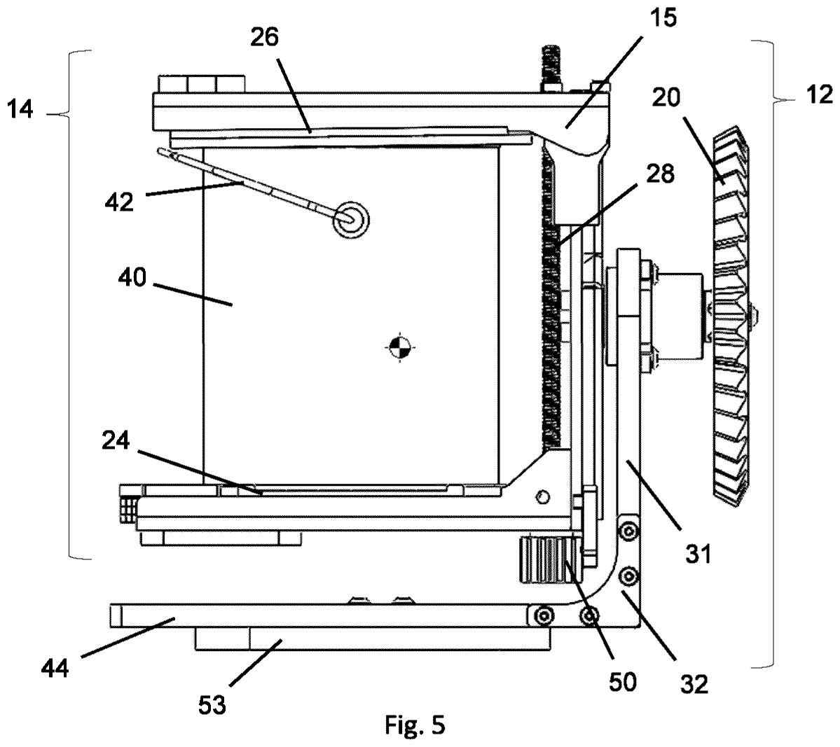

Details of the dual tumble assembly 12, as shown in FIGS. 4 and 5 are movable during vertical-axis-based rotational movement and. As shown, an indexing cam 53 is attached to a base portion 44 of the L-shaped support frame 32, and thus rotatably supports the dual tumble assembly 12 as described herein. The indexing cam 53 is preferably configured to interface with components of the base shown in FIG. 6.

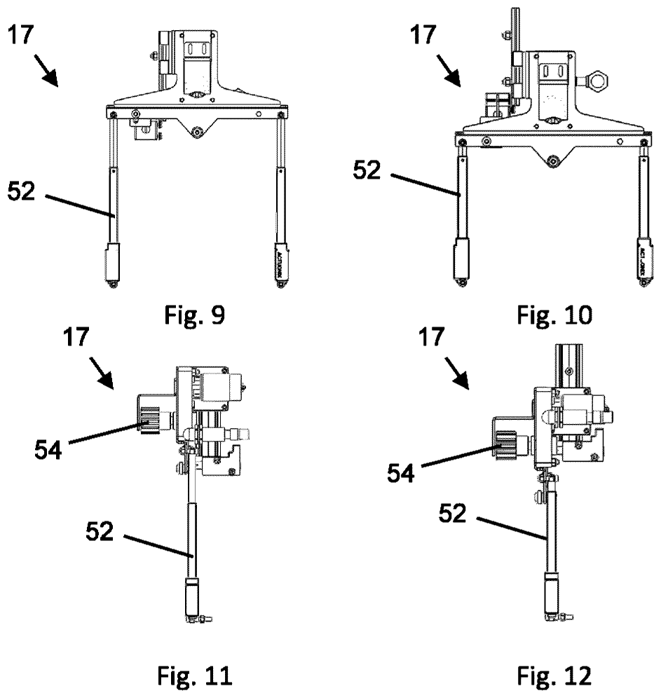

With reference also to FIG. 9, and in various embodiments, the indexing cam 53 is used particularly for slow motion indexing steps, and in some examples (not shown) linear actuators 52 pull a bearing shown in FIG. 9 against indexing cam 53. Indexing cam 53, as shown, has a slope which causes rotation until the bearing drops into the slot, thus denoting a home position.

Details of the dual tumble assembly 12, as shown in FIGS. 4 and 5 for vertical-axis-based are included as an example of an assembly given rotational movement and mixing using motor 22 via shaft 23. Base portion 44 of the L-shaped frame of FIG. 5 can be attached directly to shaft 23 shown in FIG. 6. Although specific embodiments are shown, it is understood that other combinations of bearings, shafts, frames, supports and the like are contemplated herein for enabling the double-tumble mixing action. Even yet further details of components of the dual tumble assembly 12 and clamp assembly as shown in FIG. 8, which shows various rotating components including the clamp assembly 14 and dual tumble assembly 12, but excluding the drive motor 22 and frame 32.

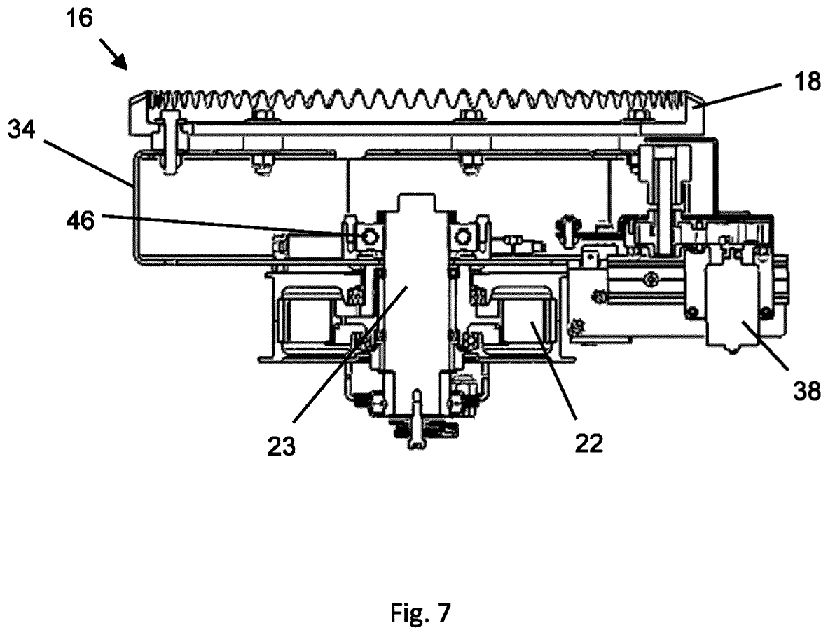

As shown in FIG. 6, the shaft 23 for motor 22 projects generally vertically from the base 16 to impart rotation about a vertical (primary) axis as a primary driven action when motor 22 is energized (optionally using a controller) and rotates. Optionally, the controller is configured to selectively control the motor 22 as a brake mechanism. Both double-tumble movements, as shown herein, preferably receive driven energy either directly or indirectly from one or more motor 22. As shown, a single motor 22 (see, e.g., FIG. 7) is utilized to enable both tumble movements through mechanical transfer of energy. In alternative embodiments, other gear trains, multiple motors, chains, and the like can be used to enable double-tumble action.

Also shown in FIG. 6 is an optional fixed circular track of base gear 18 supported by the frame 34, where the second tumble assembly comprises a gear (wheel) 20 supported by the first tumble assembly, and where the gear 20 is configured to interface with the circular track of base gear 18 such that the second rotatable assembly is caused to rotate about the second axis in response to the first rotatable assembly being caused to rotate about the first axis. As shown, a single motor 22 operates to perform both tumble movements directly and indirectly.

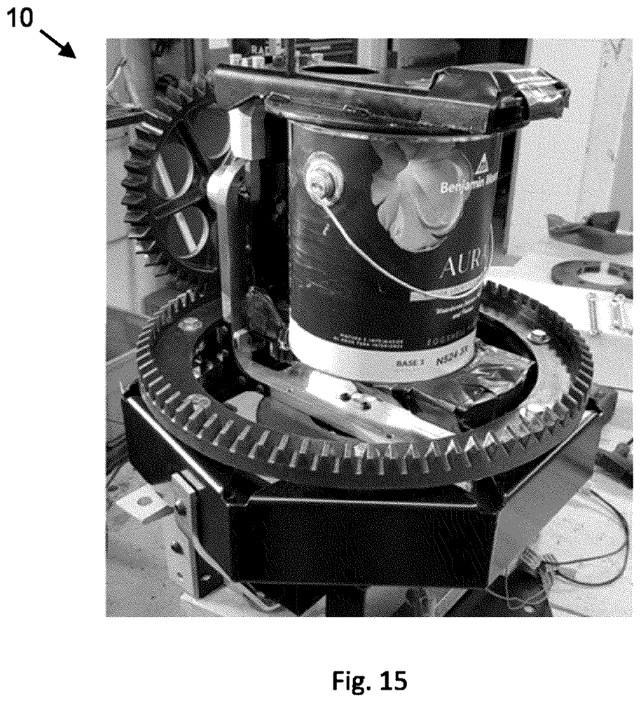

The shaft 23 is rotatably and supportably connected to the base via a motor shaft bearing 46, which itself is connected to a base bearing flange 51. Shaft 23 is preferably configured to be attachable to the base portion 44 of the frame 32. Base 16 also includes a linear actuator 52 (see, e.g., FIG. 6), which can be provided on the base 16 to selectively engage the drive motor gear 54 from the clamping motor 38 to the leadscrew 28. One embodiment of an engagement/disengagement arrangement of the gears 54 and 50 is shown, although many other variations are also contemplated, and in some embodiments the clamp motor 38 can be permanently engaged with the leadscrew 28 or the like. As shown, the linear actuator 52 performs a two-fold function of pressing a bearing 48 for indexing against an indexing cam 53, which causes the dual tumble assembly 12 to selectively rotate to the home or loading/unloading position (such as is shown in FIGS. 3 and 15). FIGS. 9 and 11 show the actuators in an extended or disengaged position, and FIGS. 10 and 12 show the actuators in a retracted or engaged position in which the clamping drive system 17 is engaged.

The tumbling clamp assembly 14 is configured to clamp onto and hold the container 40 securely while mixing. Optionally, one or more magnets (not shown) can be attached to the tumbling clamp assembly 14 to hold a container's bail 42 securely during mixing, if present. For the rotating function, the tumbling clamp assembly 14 has a gear 20, a shaft 21, and the movable top frame portion 15 that holds the container 40. In various embodiments, the top frame portion 15 of the clamp assembly 14 is configured to move along the leadscrew 28 such that the top frame portion moves up and down on the L-shaped frame 32 using two slides, e.g., one on each side of an axis supported by the L-shaped frame 32 (through which shaft 21 passes). The nut 19 moves the top frame up and down, and is preferably attached to the top frame 15. For the clamping function, there is a leadscrew 28, a gear 50 to drive it, and a top plate 26 connected to the leadscrew 28 via the clamp collar 25 The bottom plate is preferably fixed to the L-shaped frame 32 and does not move during clamping using the clamping assembly 14. The top frame 15 is configured to move up and down. Based on the expected height of a typical container (e.g., a one-gallon paint can), the rotating components of the dual tumble assembly 12 can be balanced by locating the bottom plate 24 (held in place to L-shaped frame 32 by bottom frame 27) at a distance that centers the container 40 on an expected axis of rotation.

Various sensors are also preferably provided and operatively coupled to a position sensing system and loading controller (not shown). For example, a home sensor can be included that is configured to verify that the dual tumble assembly 12 is in the home position and suitable to be loaded and unloaded. Optionally, an unlocked sensor can be configured to verify that rotating parts of the dual tumble assembly 12 would not collide with parts of the base upon mixer operation 10. One or more rotation sensor can be provided, e.g., on the end of shaft 23 driven by motor 22. The rotation sensor can be configured to determine how many degrees from the home position the dual tumble assembly 12 at a point in time.

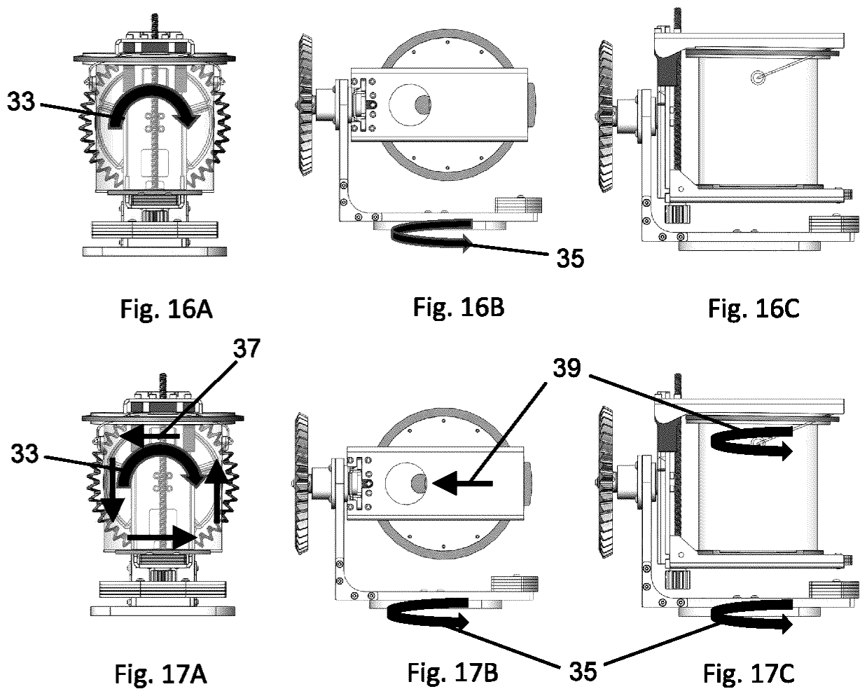

In more detail of the double-tumble mixing motion itself, the various rotational aspects of described mixing movements are shown from various angles in FIGS. 16A-16C. FIG. 16A shows a side view with a vertical axis facing up, as the motor (22) imparts (primary) rotational movement about a vertical axis. As shown, such initial, primary rotational movement about the vertical axis causes a base gear 18 and second gear 20 on the rotating assembly to mesh, and cause tumble motion 33 about a second tumble axis as shown in FIG. 16A. As described below, the vertical, motor-driven axis, also corresponds to a first tumble axis. In more detail, and with reference to FIG. 16B, a primary and first tumble action 35 about a first tumble axis also occurs. As shown, the first/primary tumble action 35 corresponds to the motor (22) movement about the vertical axis, and is also causing a second tumble action as the gears 18 and 20 and motor 22 drive rotation about the horizontal axis of tumble motion 33. FIG. 16C shows that the container (40) is held aligned with a would-be spin axis, but is preferably not spun for double-tumble mixing action.

FIGS. 17A-17C show example mixing actions within a container (40) itself when the container is being mixed with a double-tumble mixing action as shown in FIGS. 16A-16C. FIGS. 17A-17C each therefore show a separate component of a mixing action for contents (e.g., paint components) to be mixed during the double-tumble mixing action of FIGS. 16A-16C. As shown in FIG. 17A, the secondary tumble (container) movement 33 causes a corresponding fluid movement and mixing in a rotational sense shown at 37 with fluid moving directly toward the corner, such mixing being in some embodiments in the same axis but in a reversed direction compared to the primary tumble action. As shown in FIG. 17C, the primary tumble action 35 causes fluid movement 39 (e.g., at container 40 lid) that causes the contents to be mixed to move parallel to the container 40 corner(s) for an instant when the container 40 is momentarily vertical. As shown in FIG. 17B, the primary tumble movement 35 (as also shown in FIG. 16B) also causes contents to be mixed to move in a direction 39 rotating about a vertical axis (e.g., of motor 22), but in an opposite rotational direction when the container 40 is horizontal, and at least at a moment in time. Actual fluid movement during mixing is preferably a combination of the two component movements caused by tumble actions and rotations 35 and 33, respectively.

Double-tumble mixing operation as contemplated herein utilizes multiple axes for mixing. In contrast, if the container was rotated only with the rotation of FIG. 17A, little to no mixing would, occur as the container's contained fluid would eventually reach the same velocity as the rotating container 40. With the primary tumble action 35, and when the assembly is rotated 180 degrees around the secondary axis, the fluid arrows would point in the opposite direction. Preferably and for ideal mixing, fluid is moving relative to the sides of the container 40. The inertia of the fluid keeps it moving in one direction while the can is moving in the opposite direction to create shear forces against the container 40 and within the fluid. Because of this, multiple directions, actions, axes of rotation are beneficial to mix fluids in containers 40, or alternatively a change in direction (e.g., shaking movement) plus one rotational motion.

In even further detail, when the spin axis is horizonal, when using double-tumble movement, fluid is moved perpendicular to the container wall (parallel to the container top) by the secondary tumble. When the container's spin axis is momentarily vertical, fluid is moved around the can diameter by the secondary tumble action. The effect is more turbulent movement at varying angles, especially at the container 40 chime. These both aid mixing and scrubbing colorant out of areas where it can be captured, especially at the chime. The double-tumble mixing motion thus has combined advantages of shaking, vortex, and gyroscopic motions. As a further example and detail during a double-tumble mixing action, at certain times, the fluid contacts the sides of the can and the chime in a rotational fashion as occurs when the can is rotated on its axis (like current art gyroscopic and vortex motions. At certain other times during double-tumble mixing, the fluid to be mixed contacts the sides of the container 40 and the chime while moving parallel to the axis of the can as occurs with shaking motions (like current art motions shaking, agitating, both agitating and translating). In various embodiments, a combination of a tumble mixing action of a first axis with a tumble mixing action of a second axis causes fluid to be mixed to impact the chime in all directions so as to remove and mix the colorant within the container 40.

The disclosed double-tumble mixing action has numerous advantages, including faster mixing than the motions described in current art. Thus, mixing times to achieve sufficient mixing can be shorter than with other motions. Due to improved mixing efficiency and completeness, mixing speeds (and corresponding motor power levels) can also be lower than comparable existing mixers. The double-tumble mixing action further has the effect of cleaning the area where tint tends to be captured better than the motions described in current art. This area is the chime of the container 40 or the crack where the lid contacts the container 40 and the area between the top and the sides of the container 40.

In various embodiments, the secondary (tumble) axis is constantly tumbling the container end over end during mixing. The primary (tumble) axis of rotation, when combined with the primary tumble axis motion, causes the paint within the container 40 to move at all (or at least multiple) angles. An example reference point for liquid paint contents movement within the container 40 is a point at the chime (at an outer edge over the interior of the container near the top). The resulting movement of the contents in the container 40 includes turbulent movement, e.g., directly into the corner of the container 40 chime (see FIG. 17B) during part of the motion. During mixing, the paint also moves tangent to the diameter (see FIG. 17C) and all angles in between. The contents (e.g., paint colorant particles) are then scrubbed from all (or at least multiple) angles, thus facilitating removal thereof. In embodiments where there are ridges in the container 40 chime, the ridge may not protect the colorant from being swept into the body of the paint contents. The variation in direction is also true for all other interior surfaces in the container 40, but the chime area has the geometry and obstruction that prevents mixing. True double-tumble action (no rotation about the spin axis) is shown in FIG. 17B. As discussed herein, preferably a double-tumble mixing action is contemplated herein without also including a spin-axis mixing action. It is also noted that the resulting double-tumble mixing motion of the container's 40 contents is preferably caused by both primary and secondary axes, although each axis imparts a movement component as shown.

A number of variations of the double-tumble mixer and motion are also contemplated. For instance, the orientation of the two (primary and secondary) tumble axes and motions described above could be altered, at least somewhat. For example, it is shown with the two axes of tumble rotation are substantially perpendicular to each other. In variations, the two tumble axes could be at an angle to each other that is greater than or less than 90 degrees. This change could be accomplished with adjustments to various parts and configurations, to have the effect of for example 1-5 degrees plus or minus from 90, 1-10 degrees, 1-15 degrees, or more, but preferably not so far as to achieve gyroscopic movement.

Furthermore, and as shown, the can is held perpendicular to the primary tumble axis (at a point in time). This angle at which the can is held could be at an angle or greater than or less than 90 degrees. This change could be accomplished with adjustments to various parts, to have the effect of for example 1-5 degrees plus or minus from 90, 1-10 degrees, 1-15 degrees, or more, but not so far as to achieve gyroscopic movement. However, if the can is rotated 90 degrees, then this motion would become gyroscopic motion. A small angle (e.g., +/−10 degrees) could allow easier loading and unloading, e.g., because the container could be loaded/unloaded in a generally upright position facilitating horizontal movement, etc. The dual tumble assembly 12 itself could be at an angle from the vertical shaft.

Furthermore, and because the container 40 is not caused rotate about its spin axis, clamping on the container 40 be more forgiving. If the container 40 rotates on its axis, any lack of parallelism between the clamping surfaces will tend to crush the container 40. As a further advantage of disclosed embodiments, clamping onto the container 40 by the mixer 10 can be more robust or secure than other mixers. As a yet further advantage, and since there is no spinning rotation, the parts in the can clamp assembly can be simpler and easier to manufacture.

In various optional embodiments, direct drive motors and operation can be utilized for one or both tumble mixing actions, which can benefit from lower noise levels. In various embodiments, varying rotational revolutions per minute (RPM) can be facilitated according to motor selection. As discussed above, direct-drive motors are optional and not required for double-tumble mixing.

As shown in the alternative double-tumble mixer 70 of FIG. 25, a belt-based drive system including belts 72, pulleys 74, gears 76, or other means could be used to drive motion instead of the various gears as shown in embodiments of FIGS. 1-12, herein. For belt-based drive system and mixer 70, a gearbox, belts or other could be used with a motor (e.g., a single-phase or three-phase electric motor). As shown, an optional clamping arrangement that is fully boxed (supported on both sides) instead of a C-shaped clamp assembly 14 as described above. Other, non-belt-drive aspects of the belt-based double-tumble mixer 70, including tumble action details, can be similar to mixer 10, described above.

In some embodiments, two motors can be utilized with a slip ring connection or the like to transfer power to a second motor separate from the first motor through spinning components during mixing.

Utilizing double-tumble mixing action causes fluid to move in opposite directions in the chime area, namely: clockwise (when top of container 40 is up) and counterclockwise (when top of container 40 is down). Thus, fluid within the container 40 moves at many angles in this area, both perpendicular to the lid and parallel to the lid.

Applicant Test Data and Summary:

Applicant (Radia) conducted various testing to determine a comparative mixing efficiency and results for comparison with an example prior art, gyroscopic mixer. Mixer testing using a gyroscopic mixer was conducted using a 1-gallon paint can (an example of a container 40 as described herein), and was also tested using an example double-tumble mixer 10 described herein. Both gyroscopic and double-tumble mixers 10 were run at the same speeds for testing.

The purpose and objective of the testing was to test how well paint mixes using the “double-tumble” mix motion as compared to an existing gyroscopic type mixer. The equipment used included a gyroscopic mixer with DC motor as shown in FIG. 13 and a double-tumble mixer as shown in FIG. 15. All tests used the same paint and can type. Specifically, the paint used was a deep base with a large amount of tint in 1-gallon metal cans. Pigment was added at the store but not mixed prior to testing.

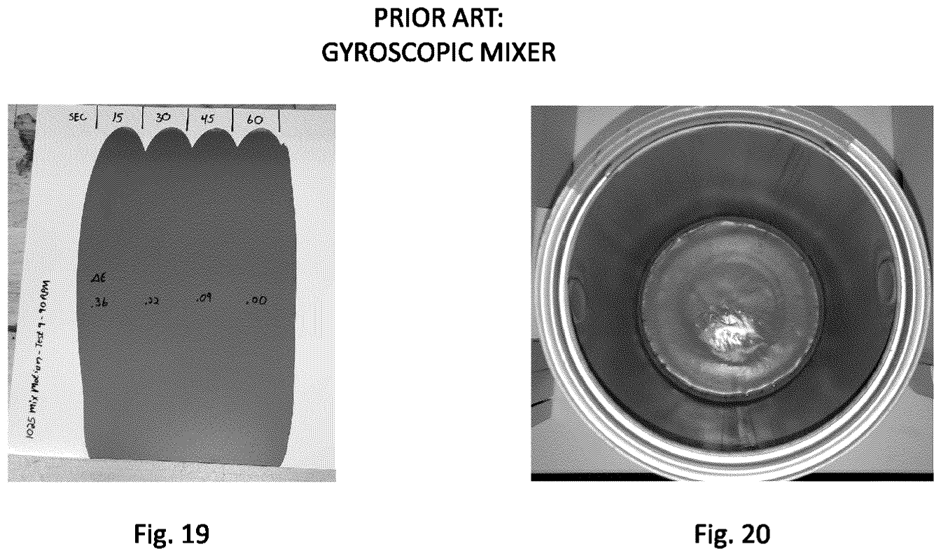

For FIGS. 19 & 21, a standard “draw-down” procedure was completed for these tests, except for doing a pour out at earlier times as noted below. Differences between tests are listed below. Test results as shown in FIGS. 19 & 20 was done with the prior art gyroscopic mixer (as shown in FIG. 13) and motion to provide a base line with which compare the difference with that mix motion and the double-tumble mix motion described herein.

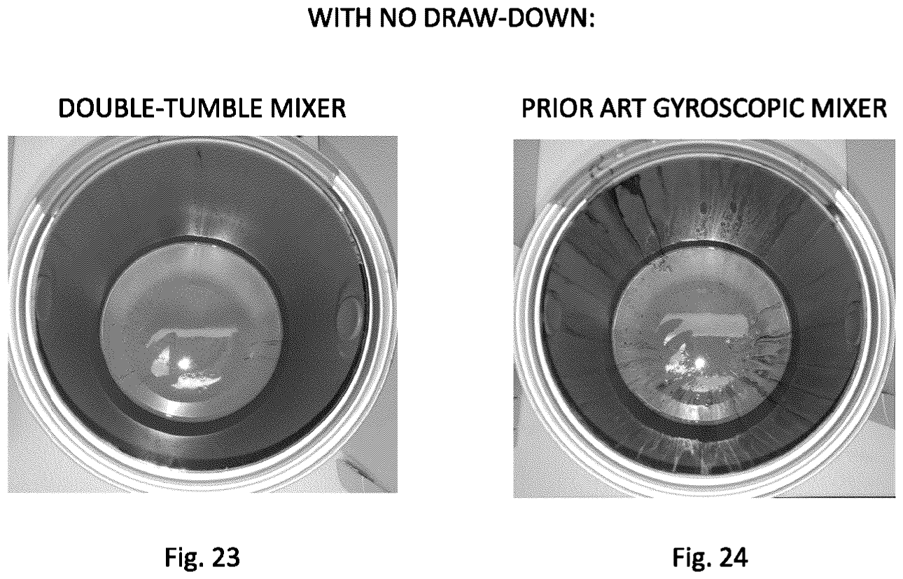

For testing as shown in FIGS. 23 & 24, two mix tests were run for 60 seconds non-stop with no draw-down samples taken and then poured out. In the case of FIG. 24, the test was done with the machine using the prior art gyroscopic mix motion (FIG. 13).

Applicant's results from testing were as follows:

For testing according to FIG. 19, the gyroscopic prior art mixer of FIG. 13 was set to 90 RPM, with a pour-out time of 60 seconds. The results for the corresponding draw-down as shown in FIG. 19, and the corresponding pour out is shown in FIG. 20.

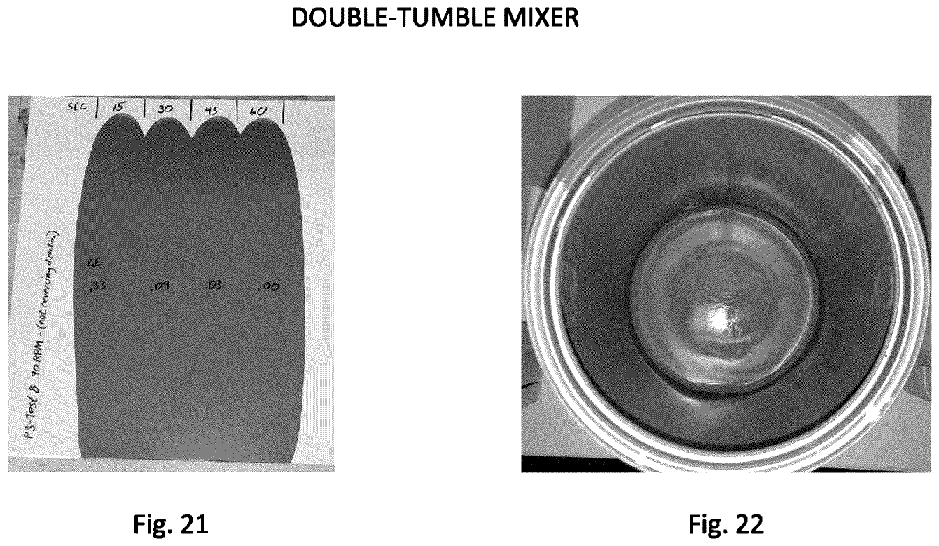

With reference to FIG. 21, the disclosed double-tumble mixer of FIG. 15 was set to 90 RPM, with a pour-out time of 60 seconds. The results for the corresponding draw-down are shown in FIG. 21, and the corresponding pour out is shown in FIG. 22. As observed in testing, and at 30 seconds, the paint is mixed more than twice as well using the double-tumble mixer 10 vs. the existing gyroscopic mixer.

For testing as shown in FIG. 23, again using the double-tumble mixer of FIG. 15, and using a 1-gallon can and set to 90 RPM, with a pour out time of 60 seconds, conducted non-stop with no draw-down samples taken. The results for test 10 pour out after 60 seconds non-stop is shown in FIG. 23.

For testing as shown in FIG. 24, using the gyroscopic mixer shown in FIG. 13 and set to 90 RPM, a pour out time of 60 seconds, conducted non-stop with no draw-down samples taken. The results of the pour-out after 60 seconds non-stop is shown in FIG. 24.

Comparing draw-down test data as shown in FIGS. 19 & 21, streaking is less prominent and is more quickly eliminated (or reduced) with the double-tumble motion and mixer. As used herein, “delta E” is a measure used to compare colors and changes thereof. If a delta E score is below 1, (or in some cases below 0.5) then a typical eye cannot detect a color change. If the delta E does not vary over time, then the paint can be considered to be “fully” mixed. It was observed that the delta E for with the double-tumble motion changes only 0.09 from 30 to 60 seconds. For comparison and for gyroscopic mixing, the delta E changes 0.22 between 30 and 60 seconds. As shown, the comparison of pour outs in FIG. 20 vs. FIG. 22 is much more dramatic and shows double-tumble mixer has 90-95% fewer streaks caused by paint caught in the chime as compared to an existing gyroscopic mixer. Stated differently, disclosed embodiments can allow for 10-20×(times) better scrubbing of a paint can (container 40) chime as compared to existing mixers.

Test results as shown in FIGS. 23 & 24 were both mixed for 60 seconds non-stop without taking draw-down samples. Streaking is much visible inside the tested can after the paint dries for the gyroscopic motion. Note that FIG. 24 streaking is far more prominent for the gyroscopic mixer than the equivalent test results using the double-tumble motion as shown in FIG. 23. As discussed herein, disclosed embodiment utilizing double-tumble mixing action can allow for 95% fewer streaks, or a 10-20×improvement over existing mixers.

In testing, it was found and shown that the double-tumble motion gets more of the paint colorant out of the chime of the can (container 40) much more effectively than the existing gyroscopic motion. Notably, streaks are reduced by 90-95% (10-20×better), as shown. For tests that used the double-tumble mix motion, the delta E's show that the paint was mixed after 30 seconds. With the standard gyroscopic motion, it required 45 seconds. See draw-down examples in FIGS. 19 and 21.

Starting and stopping or reversing the mixer rotation direction may reduce streaks in the container 40, but this stopping or reversing may also add time to the mix cycle. A user mixing contents may still observe various streaks (as shown in FIGS. 23 & 24), so actual improvement in mix time may be better than the various draw-downs would indicate.

As used herein, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Unless otherwise indicated, all numbers expressing feature sizes, amounts, time periods, and physical properties are to be understood as being modified by the term “about.” Accordingly, unless indicated to the contrary, the numerical parameters set forth are approximations that can vary depending upon the desired properties sought to be obtained by those skilled in the art utilizing the teachings disclosed herein.

The present invention has now been described with reference to several embodiments thereof. The entire disclosure of any patent or patent application identified herein is hereby incorporated by reference. The detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but only by the structures described by the language of the claims and the equivalents of those structures.

1. A multi-axis mixing apparatus, comprising:
a first motor;
a frame supporting the first motor, the first motor configured to selectively rotate a first rotatable assembly about a first axis; and
a second rotatable assembly rotatably supported by the first rotatable assembly, wherein the second rotatable assembly is rotatable about a second axis;
wherein the second rotatable assembly comprises a clamping mechanism configured to receive and hold a container containing contents to be mixed, wherein when the first motor causes the first rotatable assembly to rotate about the first axis, the rotation of the first rotatable assembly about the first axis causes the second rotatable assembly to rotate about the second axis, and wherein the second axis is substantially perpendicular to the first axis.

2. The apparatus of claim 1, wherein a third axis is substantially perpendicular to both the first axis and the second axis, wherein the third axis is a spin axis, and wherein the container is not caused to be rotated about the third axis by the apparatus.

3. The apparatus of claim 2, wherein the contents to be mixed are not caused to be mixed by a rotation about the third axis.

4. The apparatus of claim 1, wherein the first motor is a direct drive motor or a motor utilizing a belt-based drive.

5. The apparatus of claim 1, wherein the clamping mechanism of the second rotatable assembly comprises a linear clamping mechanism.

6. The apparatus of claim 5, wherein the linear clamping mechanism comprises a movable first plate that is adjustably positionable relative to a fixed second plate that is substantially parallel to the first plate at various positions.

7. The apparatus of claim 6, wherein at least one of the first plate and the second plate has at least one indentation for receiving a portion of the container.

8. The apparatus of claim 1, wherein the container is a paint can and the contents include paint components to be mixed.

9. The apparatus of claim 1, further comprising a controller and a power supply unit operatively connected to at the first motor and the controller, wherein the controller is configured to control the first motor.

10. The apparatus of claim 9, wherein the controller selectively operates the first motor at a first speed during a mixing process.

11. The apparatus of claim 9, wherein the controller selectively operates the first motor at various changing speeds and/or power levels during a mixing process.

12. The apparatus of claim 9, wherein the controller is configured to selectively control the first motor as a brake mechanism.

13. The apparatus of claim 1, further comprising a fixed circular track supported by the frame, wherein the second rotatable assembly comprises a wheel supported by the first rotatable assembly, and wherein the wheel is configured to interface with the circular track such that the second rotatable assembly is caused to rotate about the second axis in response to the first rotatable assembly being caused to rotate about the first axis.

14. The apparatus of claim 1, wherein the first axis is a first tumble axis, and wherein the second axis is a second tumble axis.

15. A multi-axis mixing apparatus, comprising:
a first motor and a second motor;
a frame supporting the first motor, the first motor configured to selectively rotate a first rotatable assembly about a first axis; and
a second rotatable assembly rotatably supported by the first rotatable assembly, wherein the second rotatable assembly is rotatable about a second axis, and wherein the second motor is configured to selectively rotate the second rotatable assembly about the second axis;
wherein the second rotatable assembly comprises a clamping mechanism configured to receive and hold a container containing contents to be mixed, and wherein the second axis is substantially perpendicular to the first axis.

16. The apparatus of claim 15, wherein a third axis is substantially perpendicular to both the first axis and the second axis, wherein the third axis is a spin axis, and wherein the container is not caused to be rotated about the third axis by the apparatus.

17. The apparatus of claim 16, wherein the first axis is a first tumble axis, and wherein the second axis is a second tumble axis.

18. A method of multi-axis mixing, comprising:
receiving a container containing contents to be mixed at a clamping mechanism such that the container is held by the clamping mechanism, wherein a first rotatable assembly rotatably supports a second rotatable assembly that comprises the clamping mechanism holding the container;
rotating the first rotatable assembly about a first axis; and
rotating the second rotatable assembly about a second axis;
wherein causing the rotating of the first rotatable assembly about the first axis causes the second rotatable assembly to rotate about the second axis, and wherein the second axis is substantially perpendicular to the first axis.

19. The method of claim 18, wherein a third axis is substantially perpendicular to both the first axis and the second axis, wherein the third axis is a spin axis, and wherein the container is not caused to be rotated about the third axis.

20. The apparatus of claim 18, wherein the first axis is a first tumble axis, and wherein the second axis is a second tumble axis.
